(19) United States
(12) Patent Application Publication
(10) Pub. No.: US 2010/0331061 A1
(43) Pub. Date: Dec. 30, 2010

(54) Apparatus for Holding a Communication Device

(76) Inventor: Joseph Gray Keliikipi, Los Angeles, CA (US)

Correspondence Address: ZUBER & TAILLIEU LLP, 777 SOUTH FIGUEROA ST., 37th FLOOR, LOS ANGELES, CA, 90017, US

(21) Appl. No.: 12/490,592

(22) Filed: Jun. 24, 2009

(51) Int. Cl. H04M 1/00

(52) U.S. Cl. 455/575.2

(57) ABSTRACT

An apparatus for securely holding a communication or mobile device for hands-free use includes an attachment portion for that is extendable from a headset or pair of glasses. A suction or adhesive system is used to removably secure a mobile device to the attachment portion so that a user can operate the hands-free apparatus without diverting visual attention from other activities.

### CROSS REFERENCE TO RELATED APPLICATIONS

Not applicable.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates generally to an apparatus for holding communication or mobile devices. Specifically, the present invention relates to an apparatus for securely holding a communication or mobile device so that a user may use the communication or mobile device without a wireless headset and without excessive hand or visual involvement.

Many jurisdictions have enacted or are in the process of enacting legislation banning the use of mobile phones and other devices while operating motorized vehicles. This has spurred the increased use of headsets with wireless technology capable of hands-free operation of a mobile device such as a cellular telephone. Indeed, hands-free mobile telephony technology has existed for several years. However, call clarity with existing hands-free mobile telephony technology is not of high quality, and general customer satisfaction remains low.

U.S. Pat. No. 7,120,247 to Wade discloses a cell phone headband in which a plurality of interchangeable attachments are used for holding a cellular phone to the headband to allow for hands-free cellular phone operation. Wade discloses a headband and a fastener member for the headband having alternate means of attaching a cell phone to the fastening member. Several different means of attaching the cell phone to the headband are contemplated by Wade: via magnetism, with a hook and loop material or with a clip. The headband portion of Wade is constructed of a flexible strip to ensure a secure comfortable fit to the user's head and at least one cushioning element to alleviate the pressure applied thereto. Wade also teaches that the headband has a removable, flexible fastener member that provides a plurality of fastening options including means utilizing magnetic, button and hook and loop material fastening means.

The methods of fastening disclosed by Wade all present problems to a user that impedes the ease of use needed by a hands-free user. The use of a button and hook and loop material requires that a cell phone have some attachments coupled to the cell phone itself, and such means of fastening might prove unstable. Also, these attachments may not be compatible with all cellular phones. Additionally, such a hook and loop material requires extensive use of a user's hands and visual concentration, making it difficult to attach while also operating a motorized vehicle. Similarly, the use of a clip may also prove unstable, may not be compatible with all cellular phones, and may require that the user divert attention, both visually and with the use of his or her hands, from operating a vehicle to attach the cellular phone to the clip.

Another of the methods of fastening disclosed by Wade, using magnets, also presents problems for the user. Use of a magnetic element may cause interference with operation of the phone itself, and may not be compatible with phones that are not substantially made of metal.

Despite the disclosure of the three different ways to fasten a cell phone to a headband in Wade, many different fastening methods are possible that are not disclosed by Wade and which would not have been obvious to one of ordinary skill in the art to try.

### BRIEF SUMMARY OF THE INVENTION

The present invention discloses an apparatus for securely holding a communication or mobile device, such as a mobile telephone, land-based or fixed telephone, recording device such as a microphone, or music player. The apparatus includes a head set adapted to be worn substantially over the top of a user's head and an attachment portion detachably and extendably coupled to a first end of the head set. The apparatus also includes a grasping piece detachably and extendably coupled to an opposing end of the head set for securely holding the headset tightly against the user's head. A suction system having at least one suction cup positioned on a surface of the attachment portion is also included, configured to removably adhere to a surface of a device for securely coupling the device to the attachment portion. Using this apparatus, a user is capable of quickly attaching and removing the device from the suction system or quickly attaching and removing the attachment portion without visual involvement.

The present invention also discloses an apparatus for securely attaching to a headset or eyeglasses to hold a communication device thereto. The apparatus includes a flexible sleeve having a insertion hole substantially positioned in a center thereof for detachably adapting to a device worn about a user's head. The flexible sleeve includes an attachment portion for securely and removably adhering a communication device thereto, the attachment portion including at least one of a suction system having at least one suction cup positioned on a surface of the attachment portion towards an end thereof and configured to adhere to a surface of a communication device, and at least one tab having an adhesive applied to both a front side and a back side thereof, the back side of the at least one tab positioned on the surface of the attachment portion and configured to removably adhere to the surface of the communication device. Using this apparatus, user is capable of quickly attaching and removing the flexible sleeve from a headset or eyeglasses positioned about the user's head or quickly attaching and removing the mobile device from the attachment portion without visual involvement.

The present invention also discloses an apparatus for securely holding a communication device. The apparatus comprises a head set adapted to be worn substantially over the top of a user's head, a padded attachment portion detachably and extendably coupled to a first end of the head set, and a grasping piece detachably and extendably coupled to an opposing end of the head set for securely holding the headset tightly against the user's head. The apparatus also comprises at least one tab having an adhesive applied to both a front side and a back side thereof, the back side of the at least one tab positioned on a surface of the padded attachment portion and configured to removably adhere to a surface of a communication device for securely coupling the mobile device to the padded attachment portion. Using this apparatus, a user is capable of quickly attaching and removing the communication device from the suction system or quickly attaching and removing the padded attachment portion without visual involvement.

Other features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

FIG. 1 is a side view of one embodiment of an apparatus according to the present invention;

FIG. 2 is another side view of one embodiment of an apparatus according to the present invention;

FIG. 3 is a view of on embodiment of an apparatus according to the present invention while in use on a user's head;

FIG. 4 is a side view of different embodiments of an apparatus according to the present invention;

FIG. 5 is a side view of another embodiment of an apparatus according to the present invention;

FIG. 6 is a side view of another embodiment of an apparatus according to the present invention;

FIG. 7 is a side of another embodiment of an apparatus according to the present invention;

FIG. 8 is a close-up view of different features of another embodiment of an apparatus according to the present invention;

FIG. 9 is a perspective view of the embodiment of the present invention as shown in FIG. 8;

FIG. 10 is a perspective view of still another embodiment of the present invention; and

FIG. 11 is a perspective view of still another embodiment of the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

It is to be understood that an apparatus 100 according to the present invention may be used with a device through which a user may either communicate and/or use to listen to or watch music or other media, or both. Therefore, the device to be used with the apparatus 100 is a communication device that may be mobile, and which may include mobile devices such as music and video players, regardless of whether such mobile devices have telephonic or messaging capabilities. Accordingly, the terms communication device and mobile device may be used interchangeably throughout this specification and shall be understood to include all types of devices capable of attaching or coupling to the apparatus 100 of the present invention.

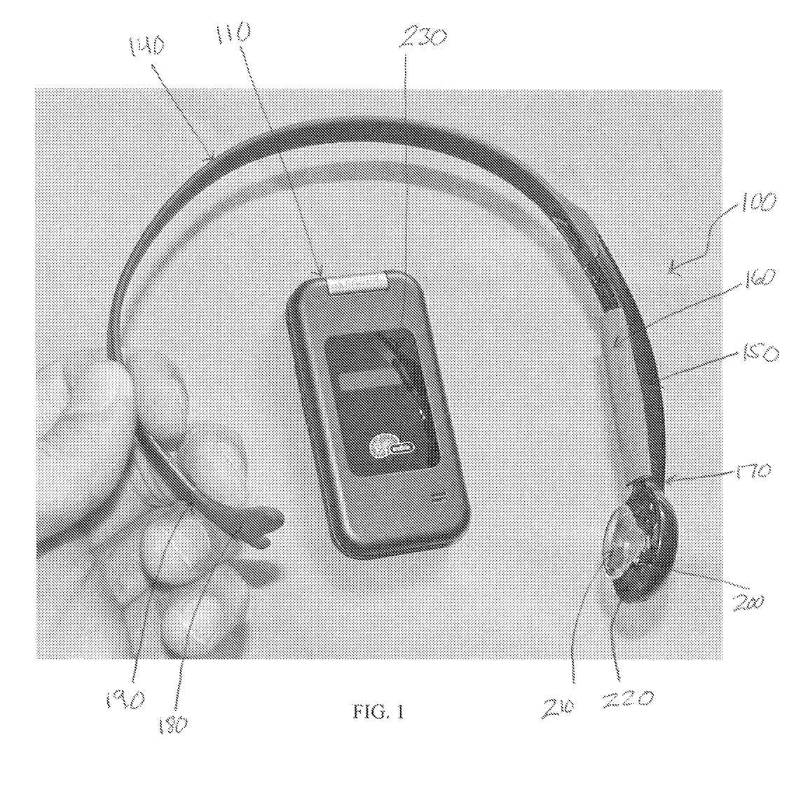

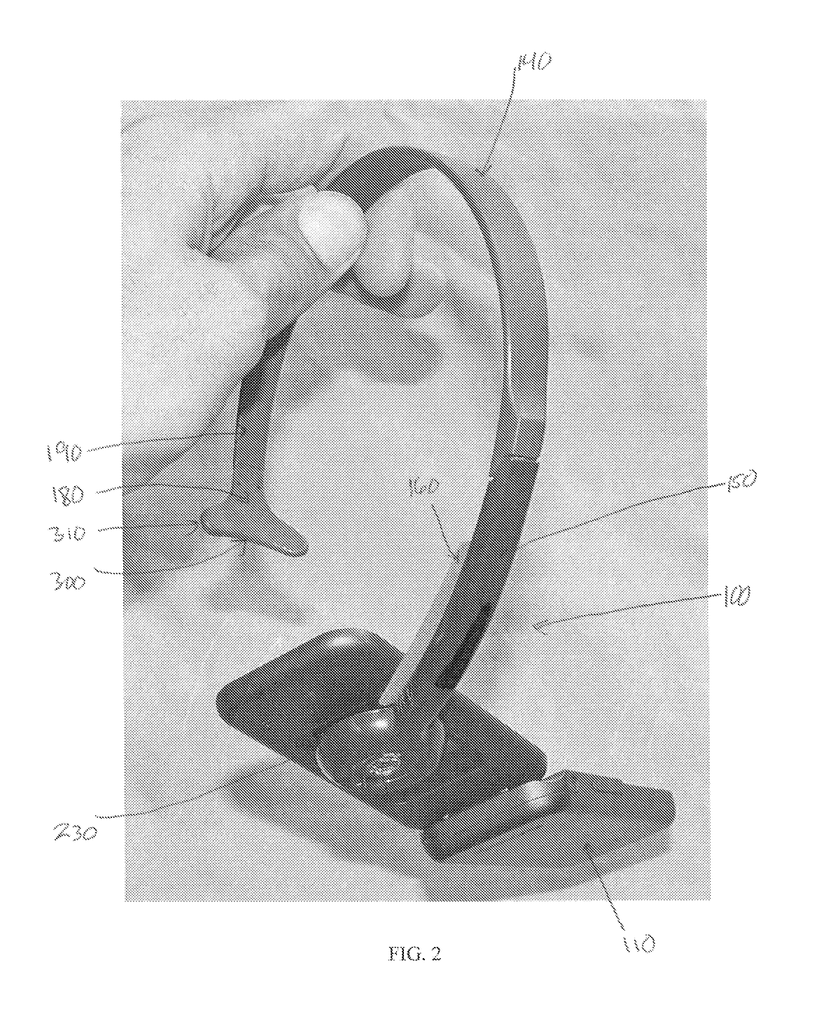

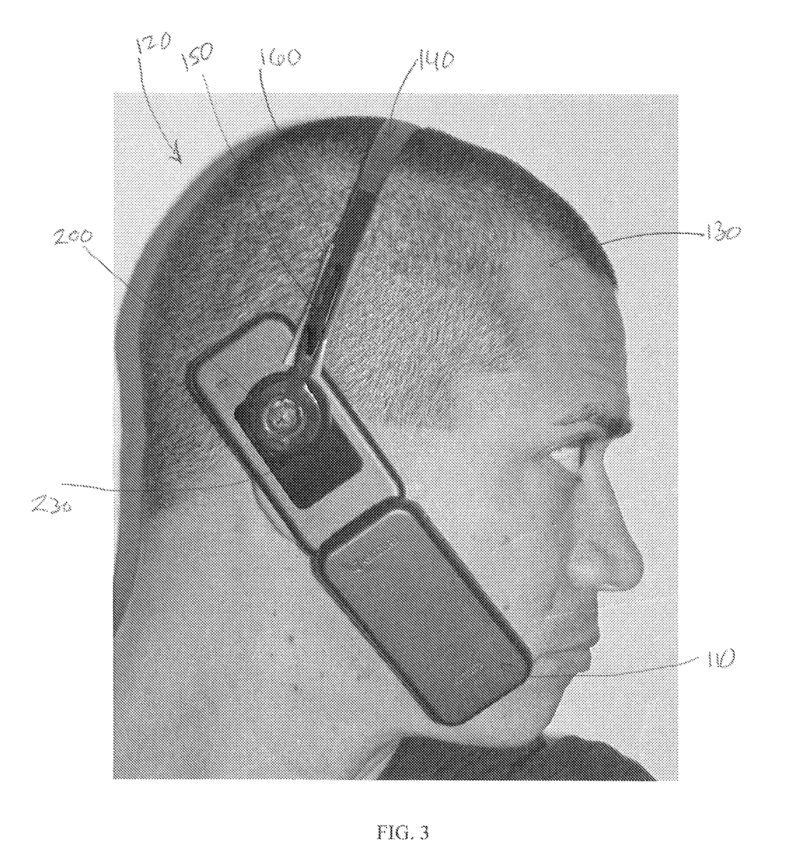

With reference to the accompanying several views of the present invention in FIGS. 1-11, an apparatus 100 for securely holding a communication or mobile device 110 to the head 130 of a user 120 according to several embodiments is disclosed. In FIGS. 1-3, the apparatus 100 includes a headset 140, an attachment portion 150 and a grasping piece 180. The attachment portion 150 is extendably coupled to a first end 170 of the headset 140, and the grasping piece 180 is disposed on a second, opposing end 190 of the head set 140. The attachment portion 150 may be padded with padding 160 for greater comfort about the head 130 of the user 120.

The attachment portion 150 includes means for adhering to a surface 230 of the communication device 1 10. In one embodiment, the attachment portion 150 includes a suction system 200 having at least one suction cup 210 on the surface 220 of the attachment portion 150. The suction system 200 and at least one suction cup 210 may be removably, yet securely adhered to the surface 230 of the communication device 110 by action of the user 120. The user 120 needs only to press the surface 230 of the communication device 110 to the at least one suction cup 210 to ensure that the communication device 110 is adhered to the attachment portion 150. This action can be done while the headset 140 is being worn by the user 120, or when the headset 140 is not being worn by the user 120. The communication device 110 can be adhered in this manner with minimal visual involvement by the user 120, resulting in a minimization of any distraction to the user 120.

The attachment portion 150 may also be extendable from the first end 170 of the headset 140 to allow the user 120 to adjust its position. The user 120 may wish to adjust the position of the communication device 110 relative to his or her and may do by sliding the attachment portion 150 up and down relative to the first end 170 of the headset 140. The present invention further contemplates that the attachment portion 150 may be detachable from the headset 140 and replaceable.

The communication device 110 may be a mobile telephone, a recording device such as a microphone, a music or video player, or any other device for which such an apparatus may be desirable for hands-free use by a user 120. One example of a communication device 110 and its use with the apparatus of the present invention is a mobile telephone used while the user 120 is operating a motorized vehicle. Because hands-free use of such a communication device 110 is not only preferable but required in some places, an apparatus with which the user 120 can easily operate the mobile device 110 without needing to use his or hands to actually operate the device, or spend a lot of time looking at it, is highly desirable. Another example of a communication device 110 is a land-based or fixed telephone that a user wishes to operate hands-free while performing other tasks. Still another example of a communication or mobile device 110 is a microphone, wherein the microphone may be attached to the apparatus 100 and a cable or other tethering device may also be coupled to the communication or mobile device 110 and/or the apparatus 100 for recording a user's voice.

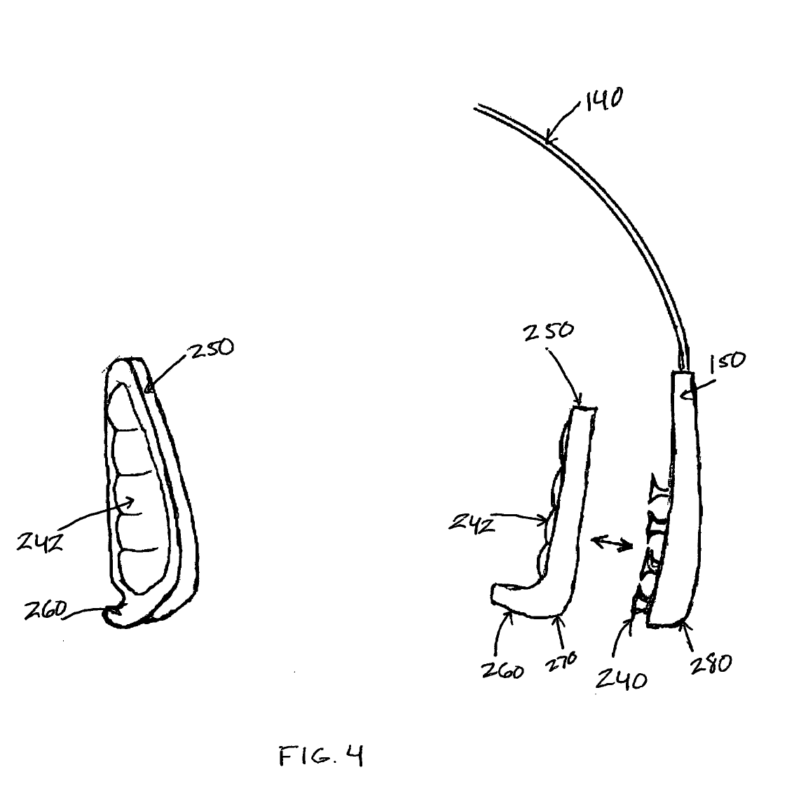

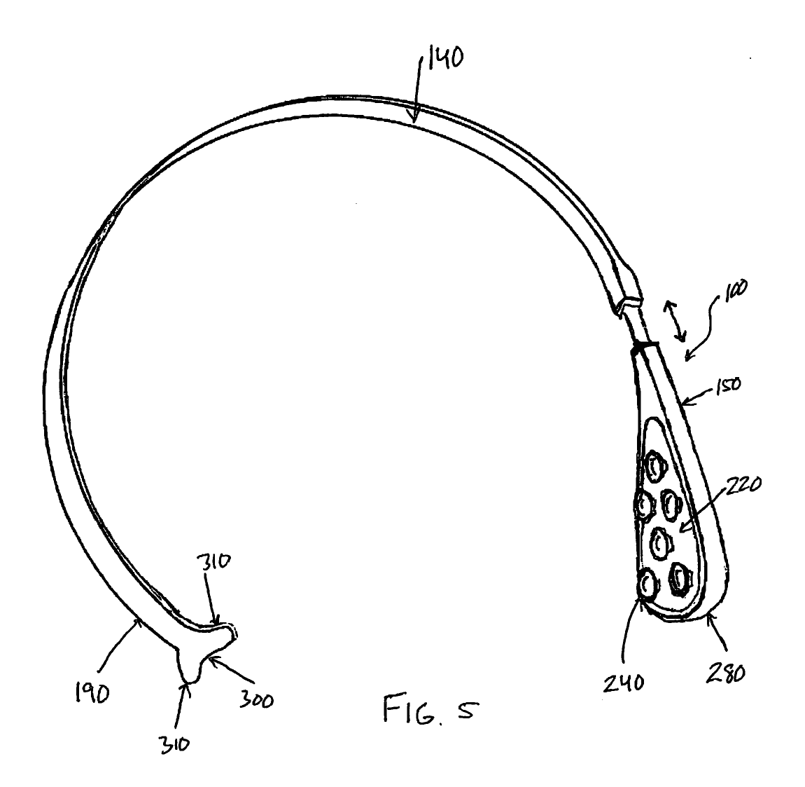

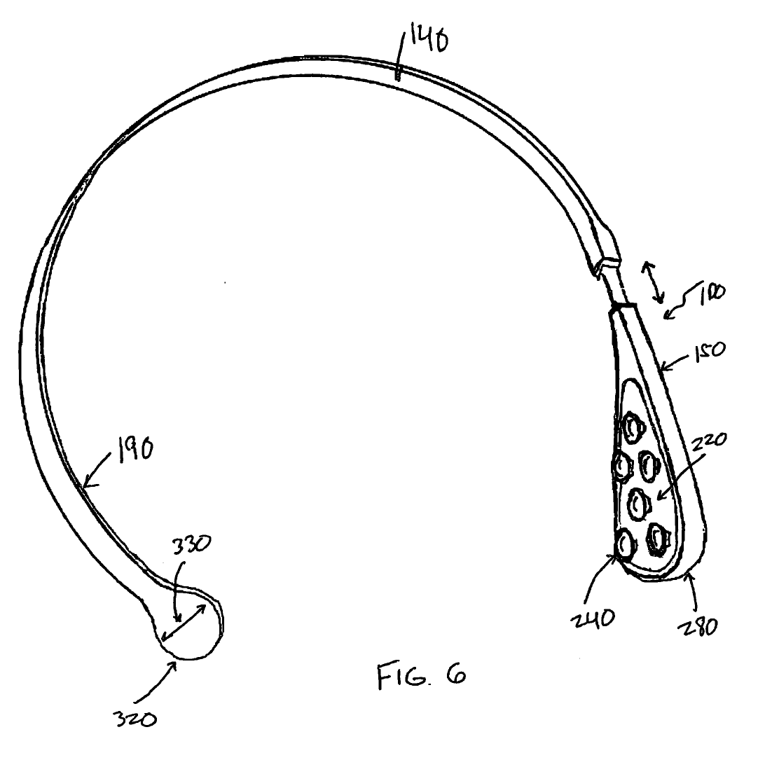

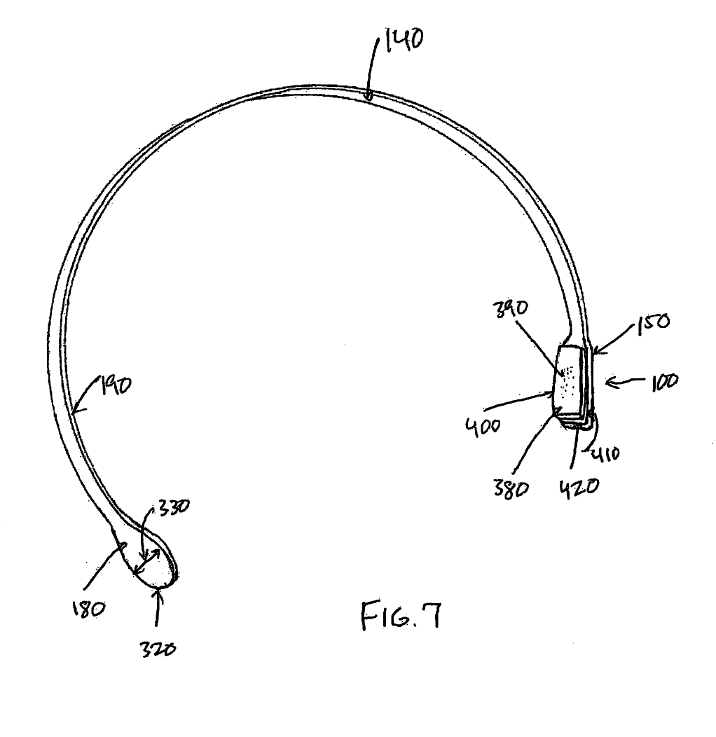

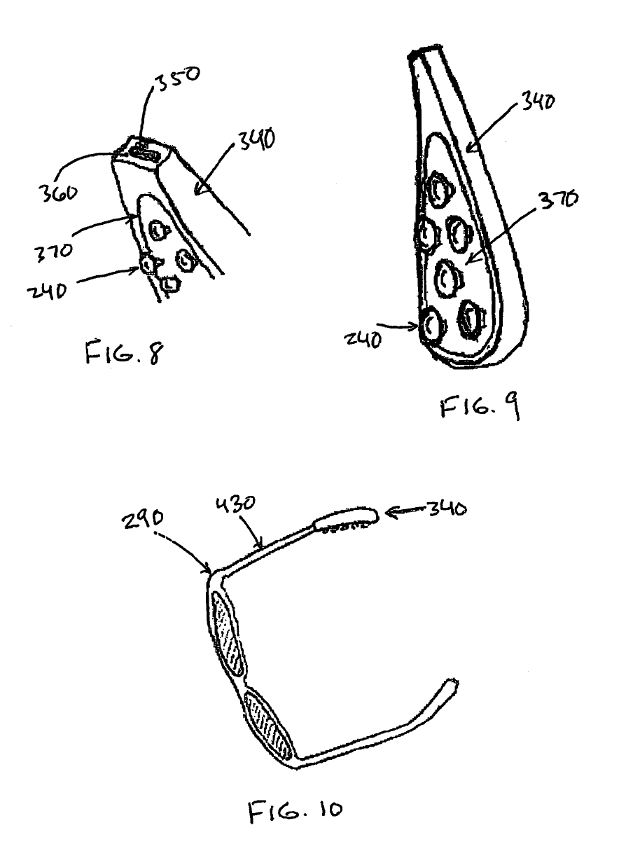

FIG. 4 shows an attachable adapter 250 that may be coupled to the attachment portion 150 to accommodate communication devices of different sizes or for a different or more comfortable fit, depending on the preference of the user 120. The attachable adapter 250 may couple to the at least one suction cup 210 or to a plurality of suction cups 240. The plurality of suction cups 240 may be used in place of the at least one suction cup 210 in the suction system 200, regardless of whether the attachable adapter 250 is utilized with the present invention.

The attachable adapter 250 may be padded with padding 242 and may include a curved seat 260 positioned on a distal end 270 of the attachable adapter 250. The attached adapter 250 itself, coupled to the means for adhering on the surface 220 of the attachment portion 150, is positioned on a distal end 280 of the attachment portion 150. The curved seat 260 allows a communication device 110 to rest in the attached adapter 250 without need for further means of adhering. Of course, the attachable adapter 250 may include further means of adhering to the surface 230 of the communication device 110.

FIG. 5 shows the grasping piece 180 disposed on the opposing end 190 of the headset 140. The grasping piece 180 includes, according to one embodiment of the present invention, a flared end 300 disposed at the end of the headset 140 and having at least one T-shaped portion 310. Alternatively, as shown in FIG. 6 and FIG. 7, the grasping piece 180 may have a rounded end 320 of a sufficient diameter 330 to prevent damage to a user's eye. Regardless of the configuration of the end of the grasping piece 180, the grasping piece 180 is configured to apply slight pressure to the head 130 of the user 120 to provide a more secure fit for the apparatus 100. To achieve the slight pressure, the grasping piece 180 may be molded separately from the headset 140 in such a fashion as to curve inward toward the head 130 and such that the grasping piece 180 cannot be bent away from the head 130. The grasping piece 180, disposed on an opposing second end 190 of the headset 140, may be removable from the headset 140 and/or extendable from the headset 140 to allow the user 120 to adjust the headset 140 for comfort. The grasping piece 180 may also be padded to provide comfort to the user 120 when the grasping piece 180 is applying slight pressure to the user's head 130.

The means of adhering a surface 230 of the communication device 110 may, in an alternate embodiment, include at least one tab 380 as shown in FIG. 7. The at least one tab 380 may include an adhesive 390 applied to both a front side 400 of the at least one tab 380 and a back side 410 of the at least one tab 380. The adhesive 390 may be any commercially available adhesive applicable to temporarily secure a communication device 110 to the attachment portion 150 by removably adhering to the surface 230 of the communication device 110. The adhesive 390 should be such that attachment and removal of the mobile device from the attachment portion is easy, can be done without a great amount of visual involvement, and does not leave substantial residue on the surface 230 of the communication device 110.

The adhesive 390 on the back side 410 of the at least one tab 380 adheres to the surface 220 of the attachment portion 150. Alternatively, in another embodiment of the present invention, the adhesive 390 on the back side 410 of the at least one tab 380 adheres to another tab 420. In this way, multiple tabs 420 can be positioned one on top of another so that the tabs, once used to adhere the attachment portion 150 to the surface 230 of the communication device 110, are removable and discarded by the user 120. The tabs 420 may be replaceable so that when all of the tabs 420 have been used, removed, and discarded, a new set of tabs 420 can be applied to the attachment portion 150.

In still another embodiment of the present invention, users 120 may attach a pair of glasses 290 to the headset 140 via a plurality of hooked extensions 280 as shown in FIG. 11. The plurality of hooked extensions 280 may be disposed anywhere on the headset 140 and spaced close enough apart to securely accept the pair of glasses 290. One feature of the apparatus 100 is therefore to accommodate a user's 120 pair of glasses 290 as well as to provide a hands-free method of using a communication device 110.

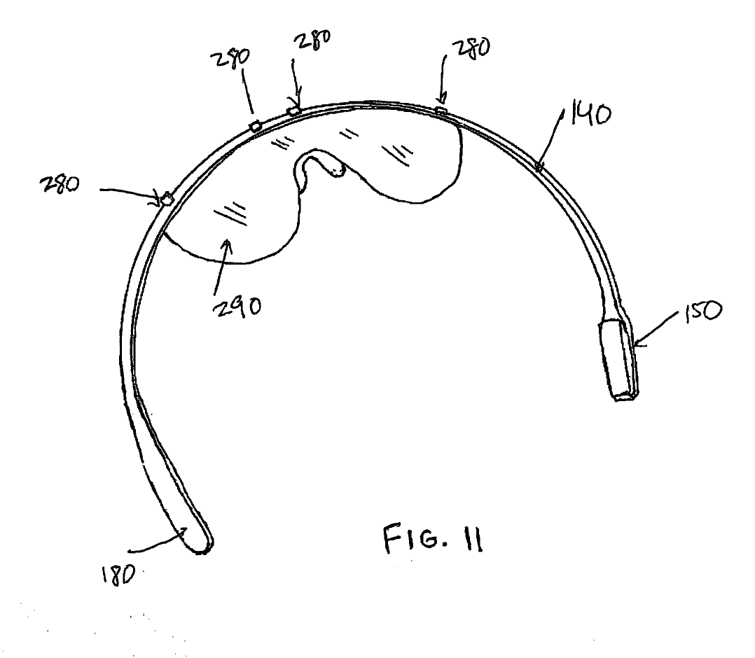

Yet another embodiment of the present invention is shown in FIG. 8, FIG. 9 and FIG. 10. A flexible sleeve 340 includes an insertion hole 350 disposed at or near a center 360 of the flexible sleeve 340. The insertion hole 350 allows a user 120 to affix the flexible sleeve to an end 170 of a headset 140 or to a frame 430 of a pair of eyeglasses or sunglasses 290 by inserting the end 170 of the headset 140 or the frame 430 of the pair of glasses 290 into the insertion hole 350. The flexible sleeve 340 includes an attachment portion 370 used to adhere to the surface 230 of a communication device 110. As above, the attachment portion 370 includes a means of adhering to the surface 230 of a communication device 110. The means of adhering shown in FIGS. 8-10 is a suction system 200 having a plurality of suction cups 240, but it is understood that other means of adhering, such as at least one tab 380 and a plurality of tabs 420 may also be employed.

The flexible sleeve 340 is removable from the frame 430 or from the headset 140 so as to be easily attached and taken off by the user 120. Additionally, the flexible sleeve 340 is adjustable to allow a user 120 to conform the positioning of the flexible sleeve 340 relative to his or her ear for greater comfort. The flexible sleeve 340 may be positioned on either side of the frame 430 of the pair of glasses 290, and is configured to easily slide onto and off of the frame 430 to allow the user to do so with minimal visual involvement to avoid distraction.

The present invention contemplates that the flexible sleeve 340 can be utilized with other headgear worn by a user, in addition to a headset 140 or a pair of glasses 290. For example, a visor having a pair of ends may also be used. One of the ends may be inserted into the insertion hole 350 so that the flexible sleeve 340 and attachment portion 370 may be utilized with the visor. The present invention also contemplates that the flexible can be adjusted and extended along an axis that is angular to the end of the headgear being used, so that the flexible sleeve can be turned at an angle relative to the end of the headgear.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. For example, the flexible sleeve 340 and insertion hole 350 may have protrusions disposed inside the insertion hole to accept the frame 430 at different positions to allow for greater security when a user 120 adjusts the positioning of the flexible sleeve for greater comfort. Additionally, the attachment portion 150 may be fixedly coupled to the headset 140 so that it is not removable therefrom, or detachable so that it can be replaced. The grasping piece 180 may also be fixedly coupled to the headset 140 so that it is not removable therefrom, or detachable so that it can be replaced Similarly, the flexible sleeve 340 may be fixedly coupled to a pair of glasses 290 and sold together as one product. It is therefore intended that the scope of the invention not be limited by this detailed description.

1. An apparatus for securely holding a communication device, comprising:
a headset adapted to be worn substantially over the top of a user's head;
an extendable attachment portion coupled to a first end of the headset;
an extendable grasping piece coupled to an opposing end of the headset for securely holding the headset tightly against the user's head; and
a suction system having at least one suction cup positioned on a surface of the attachment portion and configured to removably adhere to a surface of a communication device for securely coupling the communication device to the attachment portion,
wherein a user is capable of quickly attaching and removing the communication device from the suction system or quickly attaching and removing the attachment portion without visual involvement.

2. The apparatus of claim 1, wherein the suction system includes a plurality of suction cups.

3. The apparatus of claim 2, wherein an attachable adapter is capable of coupling to the plurality of suction cups to accommodate mobile devices of different sizes.

4. The apparatus of claim 3, wherein the attachable adapter includes a curved seat on a distal end thereof.

5. The apparatus of claim 1, wherein the attachment portion includes a curved seat on a distal end thereof.

6. The apparatus of claim 1, further comprising a plurality of hooked extensions positioned on the head set for coupling a pair of glasses thereto.

7. The apparatus of claim 1, wherein the grasping piece forms a flared opposing end with a T-shaped portions extending therefrom.

8. The apparatus of claim 1, wherein the grasping piece forms a rounded opposing end, the rounded opposing end having a sufficient diameter to protect a user's eye from being damaged.

9. The apparatus of claim 1, wherein the attachment portion is padded to provide cushion between the headset and the user's head.

10. The apparatus of claim 1, wherein the grasping piece is padded to provide cushion between the grasping piece and the user's head.

11. The apparatus of claim 1, wherein the attachment portion is extendable to allow the user to adjust positioning of the communication device.

12. The apparatus of claim 1, wherein the grasping piece is extendable to allow the user to adjust positioning of the grasping piece.

13. The apparatus of claim 1, wherein the communication device is a telephone.

14. The apparatus of claim 1, wherein the communication device is a recording device.

15. The apparatus of claim 1, wherein the communication device is a mobile music player.

16. An apparatus for securely attaching to a headset or eyeglasses to hold a communication device thereto, comprising:
a flexible sleeve having a insertion hole substantially positioned in a center thereof for detachably adapting to a device worn about a user's head, the flexible sleeve including an attachment portion for securely and removably adhering a communication device thereto, the attachment portion including at least one of a suction system having at least one suction cup positioned on a surface of the attachment portion towards an end thereof and configured to adhere to a surface of a communication device, and at least one tab having an adhesive applied to both a front side and a back side thereof, the back side of the at least one tab positioned on the surface of the attachment portion and configured to removably adhere to the surface of the communication device, wherein a user is capable of quickly attaching and removing the flexible sleeve from a headset or eyeglasses positioned about the user's head or quickly attaching and removing the communication device from the attachment portion without visual involvement.

17. The apparatus of claim 16, wherein an end of a user's eyeglass frame is inserted into the insertion hole to secure the apparatus to the user's eyeglasses.

18. The apparatus of claim 17, wherein an end of a headset is inserted into the insertion hole to secure the apparatus to the headset.

19. The apparatus of claim 18, wherein the headset is a visor.

20. The apparatus of claim 16, wherein the suction system includes a plurality of suction cups.

21. The apparatus of claim 16, wherein the attachment portion is padded to provide cushion for the user's head.

22. The apparatus of claim 16, wherein the attachment portion is extendable to allow the user to adjust positioning of the communication device.

23. The apparatus of claim 16, wherein the communication device is a telephone.

24. The apparatus of claim 16, wherein the communication device is a recording device.

25. The apparatus of claim 16, wherein the communication device is a mobile music player.

26. An apparatus for securely holding a communication device, comprising:
a head set adapted to be worn substantially over the top of a user's head;
an extendable padded attachment portion coupled to a first end of the head set;
an extendable grasping piece coupled to an opposing end of the head set for securely holding the headset tightly against the user's head; and
at least one tab having an adhesive applied to both a front side and a back side thereof, the back side of the at least one tab positioned on a surface of the padded attachment portion and configured to removably adhere to a surface of a communication device for securely coupling the communication device to the padded attachment portion,
wherein a user is capable of quickly attaching and removing the communication device from the suction system or quickly attaching and removing the padded attachment portion without visual involvement.

27. The apparatus of claim 26, wherein the at least one tab includes a plurality of tabs each tab of the plurality of tabs being removable so that a user can remove a tab when its adhesive front side or adhesive back loses its ability to secure a mobile device thereto to user's satisfaction.

28. The apparatus of claim 26, wherein the padded attachment portion includes a curved seat on a distal end thereof.

29. The apparatus of claim 26, further comprising a plurality of hooked extensions positioned on the head set for coupling a pair of glasses thereto.

30. The apparatus of claim 26, wherein the grasping piece forms a flared opposing end with a T-shaped portions extending therefrom.

31. The apparatus of claim 26, wherein the grasping piece forms a rounded opposing end, the rounded opposing end having a sufficient diameter to protect a user's eye from being damaged.

32. The apparatus of claim 26, wherein the grasping piece is padded to provide cushion between the grasping piece and the user's head.

33. The apparatus of claim 26, wherein the padded attachment portion is extendable to allow the user to adjust positioning of the communication device.

34. The apparatus of claim 26, wherein the grasping piece is extendable to allow the user to adjust positioning of the grasping piece.

35. The apparatus of claim 26, wherein the communication device is a telephone.

36. The apparatus of claim 26, wherein the communication device is a recording device.

37. The apparatus of claim 26, wherein the communication device is a mobile music player.
